(19) United States
(12) Patent Application Publication
(10) Pub. No.: US 2005/0173853 A1
(43) Pub. Date: Aug. 11, 2005

(54) Portable vise

(76) Inventor: Roger V. Maes, Lakewood, CO (US)

Correspondence Address: JACQUES M. DULIN, ESQ.;INNOVATION LAW GROUP, LTD, 224 W. WASHINGTON STREET, NETPORT CENTER SUITE 201, SEQUIM, WA, 98382, US

(21) Appl. No.: 10/773,781

(22) Filed: Feb. 6, 2004

(51) Int. Cl. B25B 1/20

(52) U.S. Cl. 269/45

(57) ABSTRACT

A portable vise includes three attachment points enabling the vise to be mounted in either a horizontal or vertical orientation, and also to allow the vise to secure one or more workpieces in a horizontal or vertical orientation. Clamps are mounted over the attachment points to mount the vise and to secure one or more of the workpieces. The clamps each include a yoke that is placed between a set screw and a jaw assembly. The yoke enables each jaw assembly to make self aligning contact for mounting the vise and for securing the workpieces.

### TECHNICAL FIELD

The present invention relates to the field of clamping devices that secure a workpiece, and more particularly, to a portable vise especially adapted for pipefitting to secure one or more workpieces that extend horizontally or vertically.

### BACKGROUND OF THE INVENTION

There are numerous known clamping devices that allow an operator to hold and securely restrain a workpiece. One well-known clamping design is a vise clamp having one stationary jaw, and one movable jaw that may be adjusted to clamp the workpiece between the jaws.

Welders and pipe fitters often use a clamp to secure a workpiece such as a length of pipe that must be cut, or welded to another length of pipe. For example, in the construction of a commercial building, there is typically a complex network of piping that must be installed to deliver water to various locations within the building as well as to accommodate the removal of sewage. Successive lengths of pipe are welded to form such pipe networks. Because of the amount of pipe that must be routed through constrained spaces, adjoining pieces of pipe must be precisely aligned prior to welding to ensure that the runs of pipe fit within the constrained spaces set forth in the building design. For most pipe fitting operations, pipe runs are created so that there are primarily horizontal and vertical runs. These runs are interconnected by 90° elbows as necessary to change the direction of the runs.

Because of the weight and size of the sections of pipe to be installed, many of the sections must be assembled at a shop location away from the job site. A job site does not typically have a bench or support that is capable of securing the pipes for assembly. Thus, one continuing problem in pipefitting is the inability for a pipe fitter to assemble sections of pipe at the job site, or to otherwise rework the pipe at the job site.

My earlier U.S. Pat. No. 3,982,739 addressed some of these problems through a portable vise formed by a pair of intersecting plates connected to an orthogonally extending base having a v-shaped cross section. The intersecting plates form two v-shaped spaces and the base forms a third v-shaped space. Clamping flanges may extend from each of the plates as well as from the base. Each clamp member is positionable over its respective v-shaped space to act as a support or frame for a set screw. The set screw is threaded through the clamp and allows a workpiece to be held in the corresponding v-shaped space formed by the intersecting plates or the base.

Another example of a device that is adapted for securing pipe includes the device disclosed in U.S. Pat. No. 5,863,035. This reference discloses a clamping device capable of being mounted to a pipe jack for securing a workpiece, such as a length of pipe. A yoke member is adapted to engage a pipe jack having a v-shaped configuration, and also has a threaded orifice for receiving a threaded stem. A handle attaches to an upper end of the threaded stem. A jaw is attached to the lower end of the threaded stem and is engageable with the workpiece by manipulating the handle to force the jaw against the surface of the workpiece.

U.S. Pat. No. 5,950,998 discloses a portable cable vise especially adapted for securing cable. The vise includes a lower stationary jaw, an upper movable jaw, and means for moving the upper jaw toward and away from the stationary jaw to grip a length of cable between jaw members. The jaws have complimentary shaped recesses for receiving the cable to avoid crushing or damaging the cable. The vise further includes a c-shaped mounting clamp allowing the portable vise to be mounted to a support.

While these inventions may be adequate for their intended purposes, none of these inventions incorporate the special features of the present invention as discussed below.

### SUMMARY OF THE INVENTION

In accordance with the present invention, a portable vise is provided that allows one or more workpieces to be secured by the device in either a horizontal or vertical orientation. The portable vise includes three available attachment points wherein one clamp can be utilized to attach the portable vise to a support, and another clamp can be used to secure a workpiece to the vise. The particular construction of the clamps allows an operator to manipulate the clamps to force a movable jaw against the workpiece, yet the operator does not have to manually guide the jaw in order to ensure that it is aligned with the workpiece to be clamped.

Two of the attachment points on the vise are formed by two pairs of converging or v-shaped engaging surfaces that are oriented back to back. The pairs of engaging surfaces are also aligned in parallel to one another so that two workpieces or a support and a workpiece would thereby extend parallel to one another. The third attachment point is defined by another pair of v-shaped engaging surfaces that are oriented perpendicular or orthogonal to the two pairs of back to back engaging surfaces. The orthogonal pair of engaging surface and the two pair of back to back engaging surfaces are an integral unit defined as the body of the vise. A pair of slots are formed adjacent each pair of engaging surfaces allowing a clamp to be positioned over any one pair of the engaging surfaces. Accordingly, there are three pairs of slots enabling a total of three clamps to be used, if necessary.

The configuration of each of the clamps may include a threaded set screw that is received within a threaded opening in the frame of the clamp. The set screw is controlled by a handle that allows a user to move the free end of the set screw to and away from a workpiece placed on the corresponding v-shaped engaging surfaces. The free end of the set screw includes a jaw assembly that may contact and hold the workpiece when the set screw is manipulated. A yoke is used to interconnect the jaw assembly to the free end of the set screw. The yoke includes a pair of lateral extensions that are received within a pair of opposed guide channels formed on an inner surface of the frame of the clamp. The guide channels are formed in the clamp so that the jaw assembly moves toward and away from the workpiece perpendicular to the surface of the work piece to be contacted. The yoke also includes a cavity that receives a flange of the jaw assembly. The cavity within the yoke is slightly larger than the flange. Accordingly, the jaw has some “play” thereby allowing the jaw to slightly shift or move when contacting a workpiece. The allowed “play” of the jaw enables an operator to secure a workpiece by simply manipulating the handle attached to the set screw. Thus, the operator does not have to manually hold the jaw to ensure that the jaw makes flush contact with the workpiece. Preferably, the jaw has a contact surface that is curved or arcuate thereby increasing the surface area of the jaw when contacting a cylindrical member such as a piece of pipe. Particularly for a jaw having a curved contact surface, without the aforementioned alignment features, the user must otherwise grasp the jaw to ensure that the jaw is properly oriented with the longitudinal axis of the piece of pipe when clamping the piece of pipe.

Other features and advantages of the invention will become apparent with a review of the accompanying figures, taken in conjunction with the detailed description.

### BRIEF DESCRIPTION OF THE DRAWINGS

FIG. 1 is a perspective view of the portable vise of the present invention;

FIG. 2 is another perspective view of the portable vise of the present invention, illustrating a pair of clamps used to secure a pair of parallel extending pieces of pipe;

FIG. 3 is another perspective view of the portable vise, illustrating use of a pair of clamps wherein one clamp secures a work piece or support in a vertical orientation, while securing either a support or a workpiece in a horizontal orientation;

FIG. 4 is yet another perspective view similar to that of FIG. 3, but showing one of the clamps securing a square-shaped member, and use of a filler between the pair of engaging surfaces;

FIG. 5 is an exploded view of a clamp illustrating its components; and

FIG. 6 is a perspective view illustrating a plurality of portable vises used within the construction of a particular pipe network.

### DETAILED DESCRIPTION

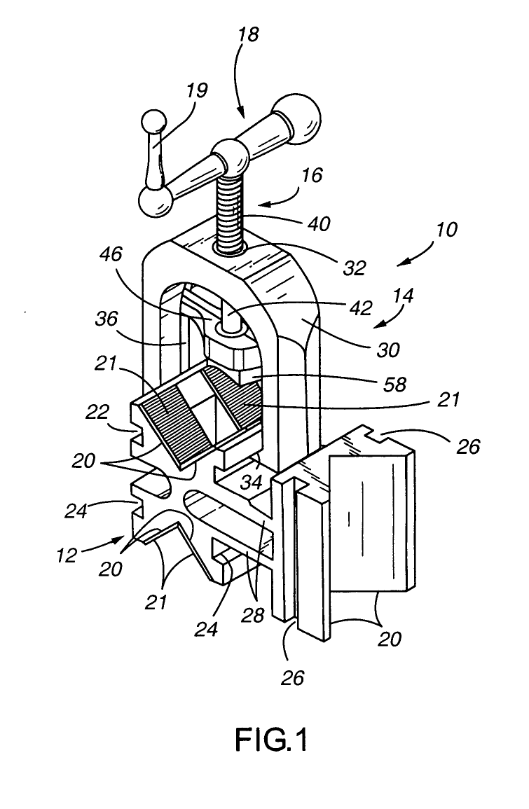

FIG. 1 illustrates the portable vise of the present invention. The major components of the vise 10 include a body 12, and one or more clamps 14 that enable the vise to be mounted to a support and to secure one or more work pieces. Beginning first with a description of clamp 14, it includes a set screw 16 that is threadably received in a threaded collar 32 mounted in a frame 30 of the clamp. A handle 18 attaches to an end of the set screwing allowing an operator to manipulate the set screw 16 which in turn causes travel of the yoke 46. The handle 18 may optionally include a perpendicularly extending knob 19 which further assists an operator in manipulating the set screw.

The body 12 is defined by three pairs of v-shaped or converging engaging surfaces 20. Two pairs of the engaging surfaces are positioned back to back with one another. The third pair of v-shaped engaging surfaces are arranged orthogonally/perpendicularly with respect to the first two pairs of engaging surfaces. The third pair of engaging surfaces is offset in its orthogonal arrangement by an extension 28 that is integral with the body 12. Each pair of v-shaped engaging surfaces includes a corresponding pair of slots that are formed exteriorly of the v-shaped openings defined by the engaging surfaces. More specifically, slots 22, 24, and 26 are formed in the body of the clamp exteriorly and adjacent to each pair of engaging surfaces 20 as shown.

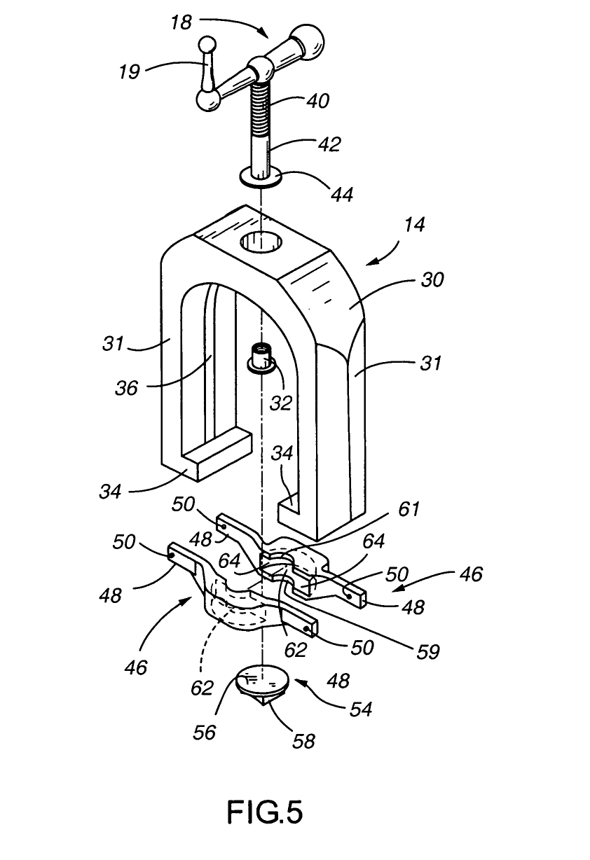

Referring also to FIG. 5, a clamp is shown in an exploded view to illustrate the components thereof. The frame 30 of the clamp includes a pair of legs 31 and engaging flanges or forks 34 that are placed within a pair of channels formed in the body of the vise, as further discussed below. An interior surface of the frame 30 includes a pair of opposing guide channels 36 that extend along the length of the legs 31. The set screw 16 is defined by a threaded portion 40 and a non-threaded extension 42. The free or distal end of the extension 42 has a flange 44 attached thereto. The yoke 46 attaches to the set screw wherein flange 44 is held within a cavity 62 of the yoke. Yoke 46 may be constructed of two mating pieces, each having a cavity formed therein to accommodate the capture of flange 44. The yoke 46 further includes a pair of extensions or ears 48 that are slidably received within the pair of guide channels 36. The two halves comprising the yoke 46 may be connected to one another as by a pair of fasteners/screws (not shown) that are received in screw holes 50. A jaw assembly 54 is also secured to the yoke 46. The jaw assembly 54 includes a flange 56, and a jaw 58. The jaw 58 may have a curved or arcuate engaging surface 60. The flange 56 is also retained in the cavity 62. As shown, cavity 62 includes a wider portion 64 that is sized to received both flanges 44 and 56. Jaw 58 protrudes through the opening 59 in the lower surface of the yoke 46. Extension 42 extends through an opening 61 formed in the upper surface of the yoke 46. The cavity 62 is sized so that there is a small gap that exists within the cavity even when the cavity has received the flanges 44 and 56. Accordingly, there is some looseness or “play” between yoke 46 and the set screw 16, and between yoke 46 and the jaw assembly 54.

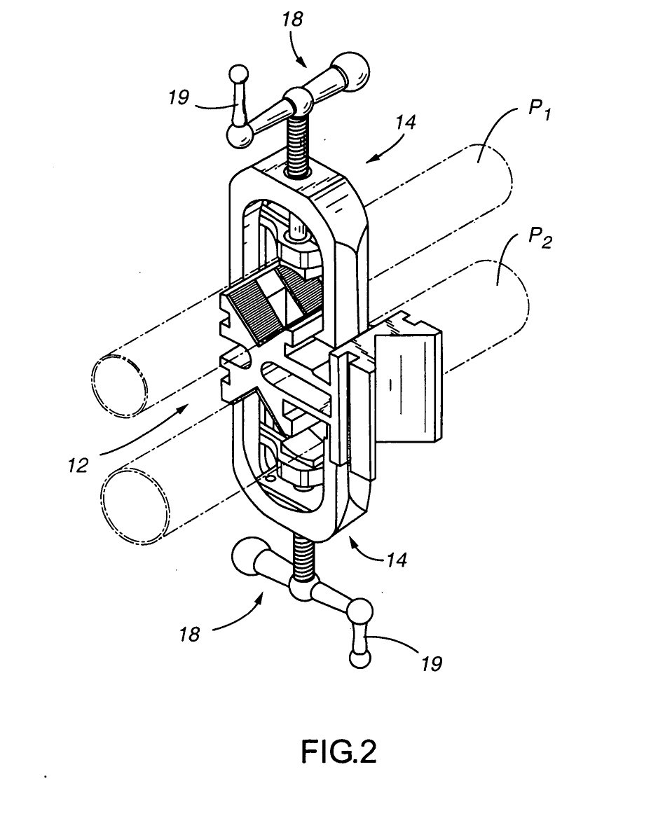

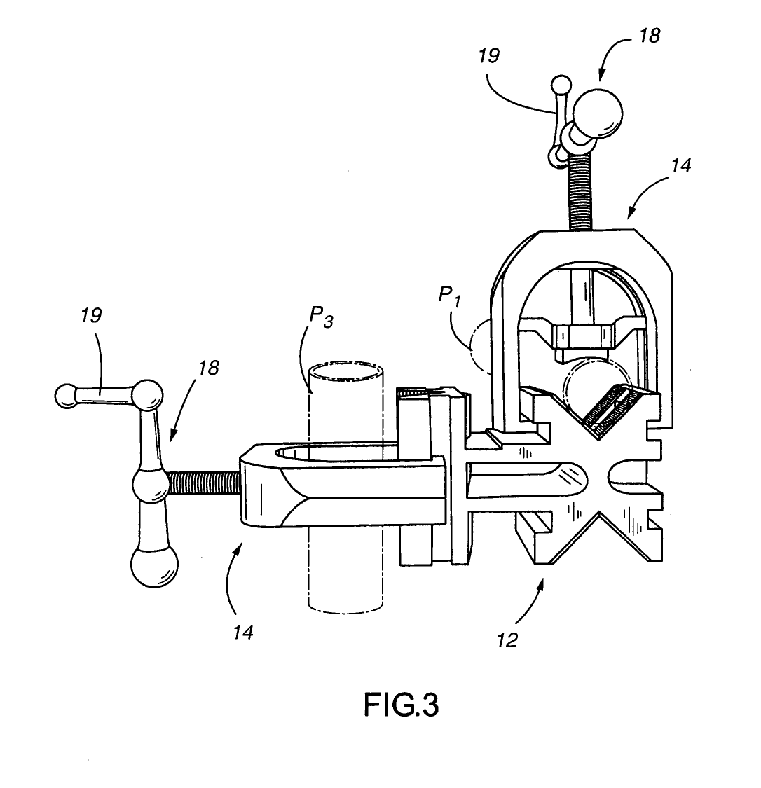

Now referring to FIGS. 2-4, the operation of the clamp will be explained. Referring first to FIG. 2, a pair of clamps 14 are shown attached to the body of the vise wherein the clamps are installed over the back to back pairs of v-shaped engaging surfaces 20. The forks 34 of each clamp are simply inserted within the corresponding pairs of slots 22 and 24. Two pieces of pipe P₁ and P₂ are shown as being engaged by the clamps. The handles 18 are rotated so to close the jaw assemblies 54 in contact with the pipes. The curved engaging surfaces 60 of the jaws accommodate the exterior curvature of the pipes thereby increasing the surface area of the jaw that contacts the pipes. In the case of FIG. 2, either of the pipes could be the piece of pipe to be worked (i.e., welded, cut, etc.), while the other pipe would be the support to which the vise is mounted. Referring now to FIG. 3, a pair of clamps are also shown; however, one of the clamps is shown as being installed over the orthogonal pair of engaging surfaces that receive a vertically extending piece of pipe P₃. In the case of FIG. 3, the work piece could be either the horizontally extending piece of pipe or the vertically extending piece of pipe, and the other piece of pipe would be the support.

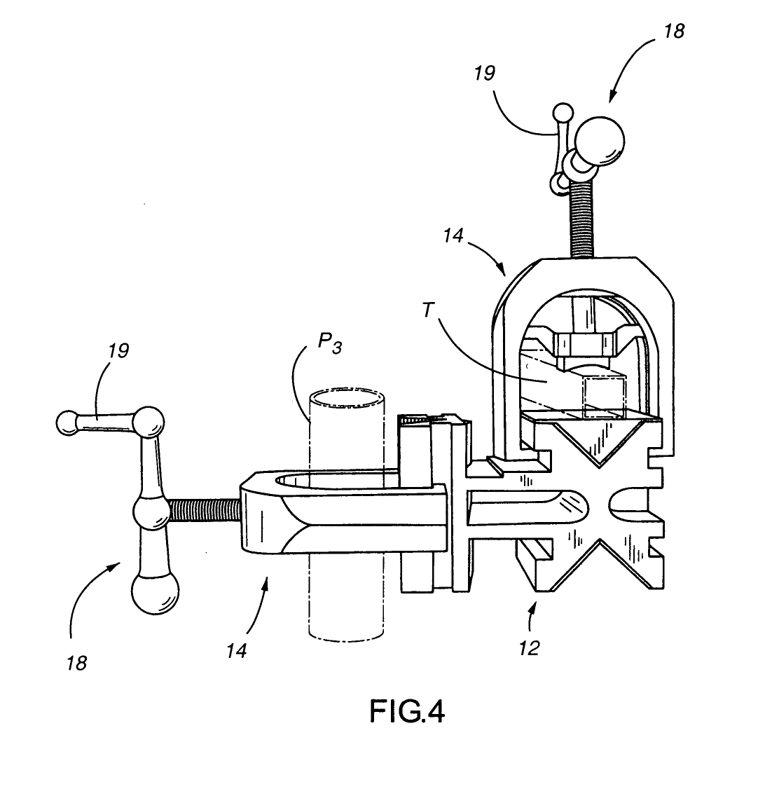

FIG. 4 illustrates the same arrangement of clamps as shown in FIG. 3; however, FIG. 4 shows the one clamp securing a piece of square tubing T as opposed to a piece of pipe. For securing a workpiece having a shape other than one with a circular cross section, a v-shaped filler 70 may be used to provide a flat engaging surface thereby increasing the surface area that is placed in contact with the clamp. A wearing plate 72 may also be installed to optimize the contact surface.

Optionally, wearing plates 21 may be installed over one or each of the v-shaped engaging surfaces 20. The purpose of the plates is to provide a contact surface with the desired characteristics in order to best secure a workpiece. In the case of iron or steel pipe members, it may be desirable to provide plates with grooved surfaces thereby increasing the frictional capacity of the clamp to prevent a pipe from spinning or otherwise shifting. Alternatively, the plates 21 could be smooth so as not to mar or otherwise damage the workpiece. For example, in the case of copper tubing, it is desirable to provide a smooth contact surface to thereby prevent potential damage to the copper tubing that might occur with the use of plates having grooved surfaces. The curved engaging surface 60 of the jaw may be smooth or may have a grooved surface like plates 21.

Yoke 46 provides a great advantage in allowing an operator to manipulate the handle 18 to secure the workpiece without having to a simultaneously grasp the jaw assembly. The jaw assembly is normally aligned so that the jaw naturally accommodates the curved exterior surface of a pipe member. As the set screw moves the yoke and jaw assembly closer to and in contact with the workpiece, the slight looseness or “play” in the jaw assembly allows the jaw assembly to naturally center itself on the workpiece. Thus, any slight misalignment between the workpiece and the jaw assembly is remedied by the ability of the jaw assembly to slightly shift or move. Thus, as the operator holds the workpiece in one hand, the operator simply secures the workpiece by using the other hand to rotate the handle 18. With the prior art, a stiff or rigid connection exists between a jaw and the member which moves the jaw in contact with the workpiece. Accordingly, there is no means to automatically correct any misalignment between the jaw and the work piece thereby forcing the operator to use both hands to manipulate the vise. Once the jaw has been tightened against the workpiece, further shifting of the jaw is prevented because the contact of flange 44 with the yoke 46 and the contact of the flange 56 with the yoke 46 is provided with enough pressure so that these pieces are locked with one another. The arrangement of the yoke and jaw assembly in the present invention provides an operator with better control over a workpiece to be secured by a vise thereby increasing efficiency and safety.

The vise heretofore described is portable, can be easily carried to the job site, and can be mounted on any bar, handrail, or stanchion, either horizontally or vertically. Thus, a workpiece may be worked on at the job site and need not be worked on at a remote shop location. The vise can be used to hold pipe, tubing, flat bars, angle iron or any other shaped work pieces. One person can easily mount the vise to a stanchion or other support, and can independently secure a workpiece without assistance. The vise can be easily detached and moved to any other location within the work area. When a clamp is tightened on the stanchion or support, the workpiece is nested in a level or plum position either paralleling the support or placing the workpiece in a perpendicular arrangement to the support. Accordingly, the workpiece is immediately ready for attachment to an existing length of pipe without having to plum and orient the workpiece.

The body of the vise may be cast or molded from a desired metal or alloy. In practice, it has been found that the body and clamps of the vise may be made from cast aluminum. Cast aluminum is both lightweight and has high strength enabling the vise to adequately secure quite heavy workpieces.

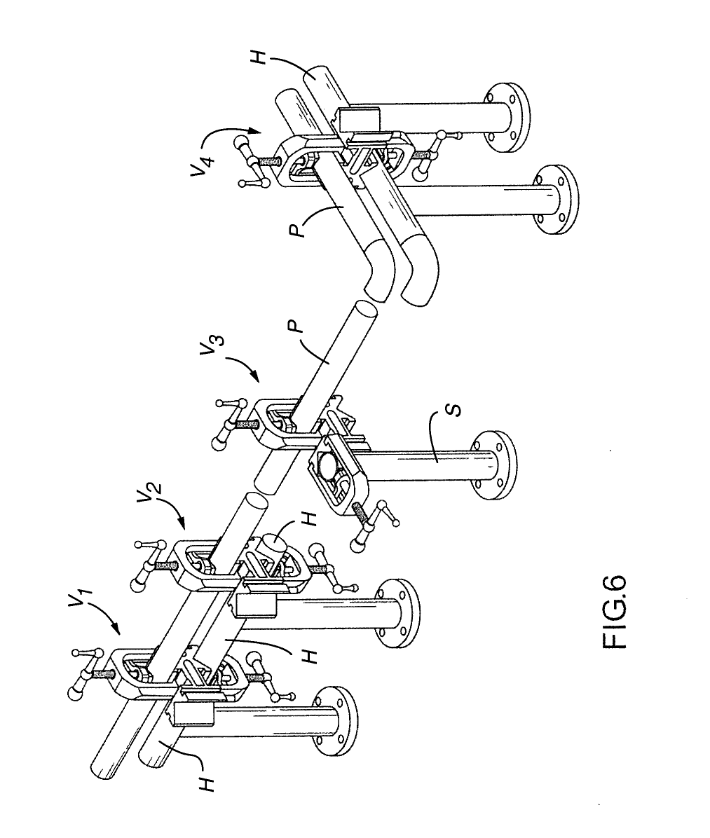

FIG. 6 illustrates a plurality of portable vises that are installed at a worksite. Two vises V₁ and V₂ are shown mounted to a horizontal handrail H and each securing a horizontal length of pipe P. A third vise V₃ is shown being mounted to a vertical stanchion S and also securing a length of the pipe P. A fourth vise V₄ is also shown spaced from the third vise V₃, the fourth vise also being mounted to a handrail H and securing a horizontal length of pipe P. Thus, FIG. 6 illustrates one example of how a combination of the vises may be used at a work site to secure various workpieces.

The present invention has been disclosed in connection with a preferred embodiment; however, various changes and modifications are contemplated within the spirit and scope of the present invention as claimed.

1. A portable vise comprising:
a base having at least one pair of converging engaging surfaces;
a clamp positionable over said base, said clamp having a screw member, a jaw, and a yoke interconnecting the jaw to the screw, said clamp further having a pair of opposing guide channels formed therein for slidably receiving said yoke.

2. A vise, as claimed in claim 1, wherein:
said jaw includes a flange and a curved engaging surface integral with said flange.

3. A vise, as claimed in claim 1, wherein:
said yoke includes a pair of extensions, each extension of said pair of extensions being slidably received in a corresponding channel of said pair of opposing guide channels.

4. A vise, as claimed in claim 1, wherein:
said yoke has a cavity formed therein for receiving a portion of said screw member and a portion of said jaw.

5. A vise, as claimed in claim 1, wherein:
said screw member has a first threaded portion and a second nonthreaded portion.

6. A vise, as claimed in claim 1, wherein:
said clamp includes a threaded opening for threadably receiving said screw member.

7. A vise, as claimed in claim 1, wherein:
said base has three pairs of converging engaging surfaces including two pairs of engaging surfaces arranged back to back, and a third pair of engaging surfaces arranged orthogonally with respect to said two pairs.

8. A vise, as claimed in claim 1, wherein:
said base includes at least one pair of slots formed adjacent said at least one pair of converging engaging surfaces for receiving said clamp.

9. A vise, as claimed in claim 8, wherein:
said clamp has a pair of legs, and a fork formed at a distal end of each leg, said forks being slidably engageable with said at least one pair of slots.

10. A portable vise comprising:
a base having at least one pair of converging engaging surfaces;
a clamp positionable over said base, said clamp having means for applying pressure to a workpiece, a jaw, and means for interconnecting said jaw and said means for applying pressure, said means for interconnecting having a cavity formed therein enabling shifting of said jaw with respect to said means for applying pressure, said clamp further including a pair of opposing guide channels formed therein for slidably receiving said means for interconnecting.

11. A vise, as claimed in claim 10, wherein:
said jaw includes a flange and a curved engaging surface integral with said flange.

12. A vise, as claimed in claim 10, wherein:
said means for interconnecting includes a pair of extensions, each extension of said pair of extensions being slidably received in a corresponding channel of said pair of opposing guide channels.

13. A vise, as claimed in claim 10, wherein:
said means for interconnecting has a cavity formed therein for receiving a portion of said means for applying pressure and a portion of said jaw.

14. A vise, as claimed in claim 10, wherein:
said means for applying pressure has a first threaded portion and a second nonthreaded portion.

15. A vise, as claimed in claim 10, wherein:
said base has three pairs of converging engaging surfaces including two pairs of engaging surfaces arranged back to back, and a third pair of engaging surfaces arranged orthogonally with respect to said two pairs.

16. A vise, as claimed in claim 10, wherein:
said base includes at least one pair of slots formed adjacent to said at least one pair of converging engaging surfaces for receiving said clamp.

17. A method of securing a workpiece comprising the steps of:
providing a portable vise including a base, said base including at least a pair of converging engaging surfaces;
providing a clamp mounted over the base;
mounting the workpiece to rest against the converging engaging surfaces;
manipulating a threaded screw integral with the clamp to simultaneously move a jaw to apply pressure against the workpiece;
maintaining alignment of the screw as it is moved by a yoke communicating with the clamp; and
shifting the jaw in relation to the yoke as the jaw contacts the workpiece in order to cause the jaw to make aligned contact with the workpiece.
